(19) United States
(12) Patent Application Publication
(10) Pub. No.: US 2022/0291383 A1
(43) Pub. Date: Sep. 15, 2022

(54) A LIDAR DEVICE, SYSTEM, AND CONTROL METHODS OF THE SAME

(71) Applicant: Nebras Ozzo, Rotterdam (NL)

(72) Inventor: Nebras Ozzo, Rotterdam (NL)

(21) Appl. No.: 17/632,997

(22) PCT Filed: Aug. 5, 2020
(86) PCT No.: PCT/QA2020/050011

§ 371 Date: Feb. 4, 2022

Related U.S. Application Data
(60) Provisional application No. 62/883,798, filed on Aug. 7, 2019.

(51) Int. Cl. G01S 17/86; G01S 17/89; G01S 17/93; G01S 7/481

(52) U.S. Cl. CPC G01S 17/86; G01S 17/89; G01S 17/93; G01S 7/4817

(57) ABSTRACT

A LIDAR device is provided. The LIDAR device includes at least a laser beam configured to cover up to 360 degrees around the LIDAR device, a mechanism configured to control a tilt angle of the at least laser beam, and an Inertial Measurement Unit (IMU), wherein the Inertial Measurement Unit includes, for example, at least a rate gyro configured to measure rotational rates and an accelerometer configured to measure translational accelerations.

### CROSS-REFERENCE TO RELATED APPLICATIONS

The present application claims priority to the PCT application No. PCT/QA2020/050011 filed Aug. 5, 2020, entitled “A LIDAR device, system, and a control method of the same”, which further claims the priority to the U.S. Ser. No. 62/883,798, filed Aug. 7, 2019, with the entire content of both applications incorporated herein by reference.

### FIELD OF THE INVENTION

The present disclosure generally relates to a Light Detection and Ranging (LIDAR) device, system, and a control method of the same. In particular, the disclosure describes a LIDAR system wherein the field of view of one or more laser beams is adjusted based on input from an inertial measurement unit.

### BACKGROUND

LIDAR systems have been widely used in different systems to scan the surrounding environment. In some implementations, LIDAR is used in a stationary setting to scan an environment, while in other implementations the LIDAR system is connected to a moving robotic platform to achieve perception and situational awareness of the environment. In many mobile robots, the LIDAR was used as a sensor to produce points-of-clouds about the environment independent of the robot state. Thus, regardless of the robot's speeds, pose, environmental conditions, or other factors, the LIDAR operates in the exact same way. Linking the LIDAR configurations to robot motion has a huge benefit in optimizing the overall operation of an autonomous robot. This is similar to a human driving a car or other forms of transportation means such as a bicycle when the human vision system changes its behavior based on the state of the vehicle, the surrounding environment as well as the action to be taken. If a person is moving backward, more attention is given to the environment behind the vehicle. If the person is moving slowly, more attention is paid to the nearby obstacles, but when moving fast, the attention is focused on longer ranges. Many LIDAR systems in the market solve this problem by adding many beams rotating at very high rotations per second (RPM). This results in hundreds of thousands of points and in some systems millions of points being generated per second. These points can generate a high-fidelity 3D map of the environment. However, the cost of the system becomes very expensive, the computational resources needed to process the data become larger and require more power, inhibiting many lightweight applications to use LIDAR due to their limited power and computational resources.

### SUMMARY OF THE INVENTION

The present disclosure generally relates to a LIDAR device, system, and control methods of the same.

According to one non-limiting aspect of the present disclosure, LIDAR device includes at least a laser beam configured to cover up to 360 degrees around the LIDAR device, a mechanism configured to control a tilt angle of the laser beam, and an inertial measurement unit.

According to another non-limiting aspect of the present disclosure, a LIDAR system includes at least a laser beam configured to cover up to 360 degrees around a LIDAR device, a mechanism configured to control a tilt angle of the laser beam(s), and an inertial measurement unit.

According to another non-limiting aspect of the present disclosure, a method for operating a LIDAR device includes linking a robot motion with a LIDAR device configuration, and linking a robot orientation with the LIDAR device configuration.

Additional features and advantages are described herein, and will be apparent from the following Detailed Description and the figures.

### BRIEF DESCRIPTION OF DRAWINGS

Features and advantages of the present technology including a LIDAR device, system, and control methods of the same described herein may be better understood by reference to the accompanying drawings in which:

FIG. 1 illustrates a LIDAR system according to an embodiment of the present disclosure.

FIG. 2 illustrates a LIDAR system according to an embodiment of the present disclosure.

FIGS. 3A and 3B illustrate two 3 beam LIDARs with a different vertical field of view (FOV).

FIGS. 4A-4C illustrate extended vertical FOVs.

FIG. 5 illustrates a need for changing orientation for different types of aerial robots.

FIG. 6 illustrates beam geometry when the LIDAR is placed on a flat platform.

FIG. 7A illustrates an example of an aerial robotic platform titled an angle to achieve a specific maneuver; FIG. 7B illustrates how a traditional LIDAR reacts to the change in platform inclination; FIG. 7C illustrates how a dynamic tilt LIDAR can change the tilt angle of the beams to maintain the same area of interest under scanning.

FIG. 8 illustrates an adjusting vertical FOV of a flying robot during takeoff/landing and during normal maneuver according to an embodiment of the present disclosure.

FIG. 9 illustrates an adjusting vertical FOV of a flying robot during takeoff/landing and during normal maneuver according to an embodiment of the present disclosure.

FIG. 10 illustrates a flow chart of the control loop for controlling the motion of a ground robot using LIDAR according to an embodiment of the present disclosure.

FIG. 11 illustrates a flow chart of the control loop for controlling the motion of a ground robot using LIDAR according to an embodiment of the present disclosure.

FIG. 12A illustrates a dynamic tilt LIDAR controlling the motion of a ground mobile robot according to an embodiment of the present disclosure; FIG. 12B illustrates a ground mobile robot moving relatively faster than the ground mobile robot illustrated in FIG. 12A; FIG. 12C illustrates a ground mobile robot moving faster than the ground mobile robot illustrated in FIG. 12B; FIG. 12D illustrates a ground mobile robot reaching high speed according to an embodiment.

FIG. 13 illustrates a region of interest scanning according to an embodiment of the present disclosure.

FIG. 14 illustrates a humanoid robot with an integrated LIDAR

FIG. 15A illustrates an aerial robotic having a LIDAR with Inertial Measurement Unit (IMU); FIG. 15B illustrates an aerial robotic having a traditional LIDAR; FIG. 15C illustrates an aerial robotic having a new LIDAR with Inertial Measurement Unit (IMU) according to an embodiment of the present disclosure.

The reader will appreciate the foregoing details, as well as others, upon considering the following detailed description of certain non-limiting embodiments of the present technology including a LIDAR device, system, and a control method of the same. The reader may also comprehend certain of such additional details upon using the present technology including the LIDAR device, system, and the control method of the same.

### DETAILED DESCRIPTION OF EMBODIMENTS

The present disclosure generally relates to a LIDAR device, system, and control methods of the same.

In the present disclosure, a more efficient way of using the LIDAR proposed, namely to adjust its parameters according to the robot motion, is proposed. In one embodiment, the LIDAR parameters are adjusted based on the robot's motion and orientation. This can be done using an integrated Inertial Measurement Unit (IMU) positioned inside the LIDAR unit or otherwise associated therewith. Alternatively, the IMU can be part of the robotic platform, and the data interface between the robot's IMU and the LIDAR unit is used to stream the IMU readings to the LIDAR. The IMU encompasses at least a rate gyro that measures rotational rates about the three body fixed axes, an accelerometer that measures translational accelerations along the three body fixed axes. The translational accelerations and the rotational rates can be used to extract information about the robot configuration and motion in a global inertial frame of reference. To enhance the estimates about the robot configuration and motion, data from the robot can be fed to the LIDAR system through various communication buses. Such information could be wheel odometry for a ground mobile robot, joint angles of an articulated manipulator such as robotic arms, walking robots, snake robots, etc., GPS data from an aerial robot, or other forms of information about the motion or configuration from various robot designs.

In another embodiment of the present disclosure, two approaches are used to adjust the parameters of a LIDAR system. In the first approach, knowing the current robot configuration may be used to determine what LIDAR parameters would result in scanning the most important region of the environment. In the second approach is that knowing the current robot configuration, and the action to be taken may be used to determine what LIDAR parameters would result in scanning the most important region of the environment.

The first part can be done by estimating the robot motion using an integrated Inertial Measurement Unit (IMU) positioned inside or otherwise associated with the LIDAR unit.

The IMU encompasses at least a rate gyro which measures rotational rates about the three body fixed axes, an accelerometer which measures translational accelerations along the three body fixed axes. The translational accelerations and the rotational rates can be used to extract information about the robot configuration and motion in a global inertial frame of reference.

In embodiments, the LIDAR parameters are adjusted based on the robot motion. This can be done using an integrated IMU associated with the LIDAR unit. Alternatively, the IMU can be part of the robotic platform, and data interface between the robot's IMU and the LIDAR unit is used to stream the IMU readings to the LIDAR.

To enhance the estimates about the robot configuration and motion, data from the robot can be fed to the LIDAR system through various communication buses. Such information could be wheel odometry for a ground mobile robot, joint angles of an articulated manipulator (such as robot arms, walking robots, snake robots, etc), GPS data from an aerial robot or other forms of information about the motion or configuration from various robot designs. The second part related to knowing the next move for the robot has to be communicated from the robot computer to the LIDAR system.

According to an embodiment of the present disclosure, a LIDAR system includes at least a laser beam configured to scan up to 360 degrees around the main vertical axis of the system; a mechanism configured to dynamically control a vertical angle of the laser beams, an IMU configured to estimate the system configuration and motion; an embedded real-time software for collision avoidance, localization and mapping, and a communication channel configured to exchange data with the robot.

According to an embodiment of the present disclosure, the LIDAR system has a rotating mechanism to rotate the beams about the vertical axis of the system. In a spherical coordinate format, this angle is the azimuth angle. Absolute angle feedback is added to the rotating mechanism to precisely control its position and speed. A rotating mechanism is present to control the vertical tilt angle of the laser beams. Absolute feedback on angle is also used to control the speed and the position. A laser sensor is connected to the second rotating mechanism and rotates with it to achieve up to 360 degrees. This laser sensor may comprise a single beam or a multiple beam sensor with various vertical field of view. A protective cover to enclose the components of the system. A base may be further provided where the lower rotating mechanism is mounted on. The base contains the electronics required for system control. It also has suitable interfaces allowing the system to be connected to other systems like a robot computer, a personal computer or other devices. The system also contains an Inertial Measurement Unit (IMU). Such a device is able to calculate the orientation of the LIDAR system. The device made as a low-power device and can be used in mobile applications.

FIG. 2 illustrates an embodiment of the present disclosure. The LIDAR system has a lower brushless DC motor (BLDC) to rotate the beams about the vertical axis of the system. In a spherical coordinate format, this angle is the azimuth angle. An absolute encoder is added to the lower BLDC to precisely control its position and speed. A second BLDC to control the tilt angle of the laser beams. An absolute encoder is also used to control the speed and the position of the motor. A laser sensor is connected to the second BLDC motor and rotates with it. This could be a single beam or a multiple beam sensor with various vertical field of view. A non-rotating protective cover to enclose the components of the system. A base where the lower BLDC motor sets. The base contains the electronics required to control the motors and laser sensor sender and receiver. The LIDAR system also has one or more interfaces which allow connection to other systems like a robot computer, a personal computer, or other devices. The base also contains an Inertial Measurement Unit (IMU). Such device is able to calculate the orientation of the LIDAR system. The device is a low-power device and can be used in mobile applications.

A LIDAR design having a solid state LIDAR covering 360 degrees around the main vertical axis can also be used for the purposes of this invention. For controlling the vertical angle of the beams, a MEMS based mechanism or optical based mechanism, or other suitable mechanism can be used as well in closed loop control or any other control regime based on input from the IMU.

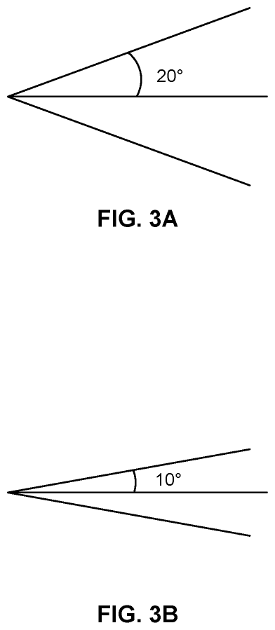

In a conventional LIDAR system, there is only one axis of rotation about which the beams rotate to create a 3D point cloud of the environment. This axis of rotation usually provides the LIDAR system with a 360-degree horizontal field of view (FOV). However, the vertical field of view is limited to the number of beams and the separating angle between them. FIGS. 3A and 3B show the beams of a three-beams LIDAR. FIG. 3A has a larger separation angle and thus can cover a larger vertical FOV than the schematic on the right. However, the LIDAR in FIG. 3B produces closer points that better represent the environment.

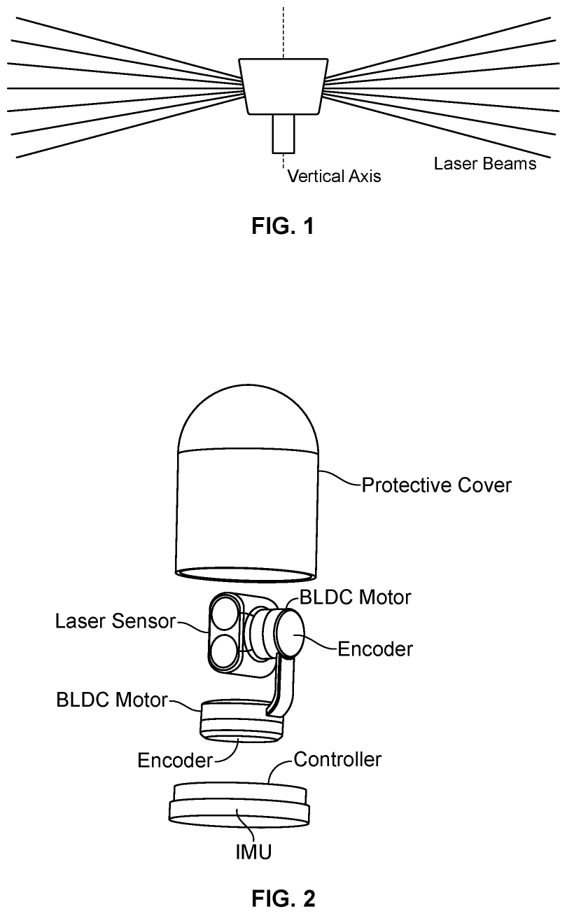

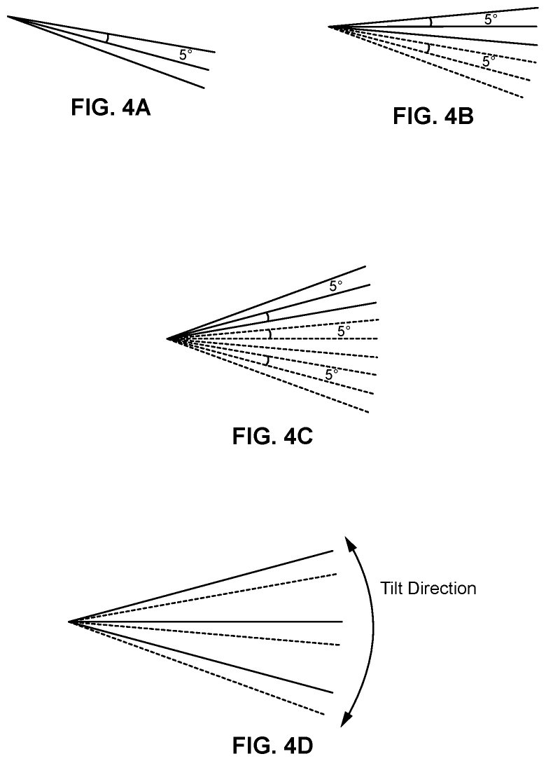

With the ability to vary the vertical field of view, a smaller separating angle between the beams can be used to reduce the distance between the points. Those beams can then be tilted to cover a larger vertical FOV. FIGS. 4A-4C illustrate how the dynamic tilting of the beams increases the vertical field of view according to the invention. To demonstrate the advantage of dynamic tilting, a separating angle smaller than those in FIG. 1 is used. In FIG. 4A, the lower rotating mechanism rotates the beams and covers a wedge of 10°. Once the lower rotating mechanism completes a full rotation, the tilt motor raises the beams up to cover another wedge in the environment. FIG. 4B shows the beams after being tilted up. The solid beams are the beams in the current rotation while the dashed beams represent the beams' locations from previous rotations. FIG. 4C shows the final vertical covered FOV and the density of the points collected. A laser sensor with wide angle of separation in the vertical field of view can be used in a similar manner to cover larger vertical FOV. The speed of the scanning can be controlled by the size of the step in the vertical direction. The separation angles used in this example are merely selected to represent the concept and are not considered to be limiting the scope of the invention, as other vertical angles of separation can also be used with smaller or larger values in other embodiments.

This advantage can be used to speed up the scanning process when the LIDAR is scanning the environment while not moving. The same also applies to a moving platform. The LIDAR system is able to scan the full environment with a minimal dead zone. Additionally, the user can choose to scan a smaller portion of the environment both in the vertical and the horizontal FOV. An example of this approach would be scanning a room, or a LIDAR mounted on a mobile robot that is recreating an environment. The robot in this case could be either moving at low speed or moving and stopping in a sequential manner.

Since the main concept of the invention is based on changing the vertical angle of the sensor to get denser point of cloud (POC) of the environment, the same technique used above can be used with a sensor having a large vertical angle of separation between the beams as illustrated in FIG. 4D. By controlling the angular steps in the vertical direction, a high density POC can be generated. The schematic in FIG. 4D shows how a sensor with large vertical angle of separation can generate denser POC by titling the beams in the vertical direction with a small angular step. The density of the POC is then controlled by the size of the angular step.

It should be understood that the movement of the laser beams in the vertical direction is not limited to a constant step increase in the upward or the downward direction. The beams could be following a sinusoidal pattern of moving up and down rapidly. The path of the beam is left up to the user based on what works best for the end application. The limitation of how fast the beams can be moved up and down or what path they follow is not a limitation of the control software which is part of the novelty of the enclosed invention, but rather a limitation of the physical mechanism used to control the vertical angle of the laser beams. In MEMS-based mechanisms or using optical techniques, a high speed vertical FOV change can be achieved.

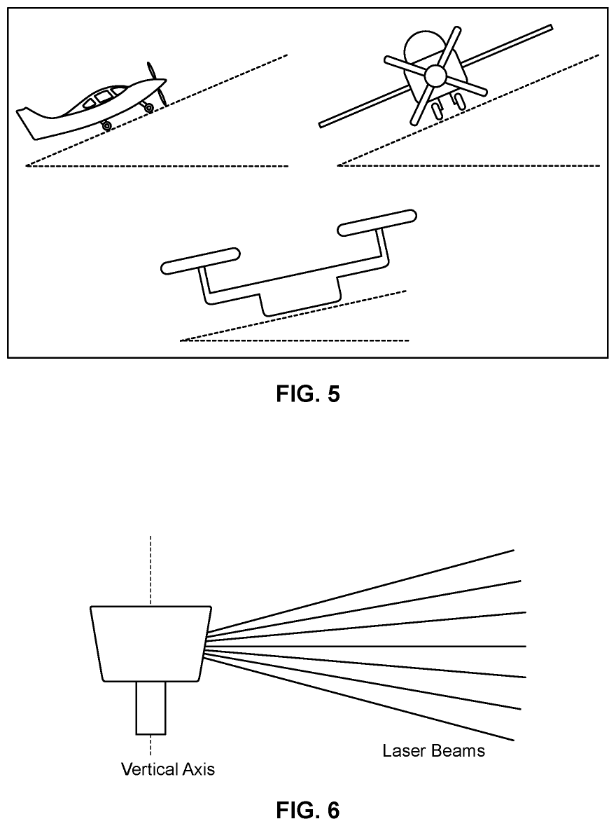

Most aerial robots require a change of orientation of the robot body to move vertically, forward, backward, or sideways depending on the vehicle design. FIG. 5 shows how a fixed-wing robot concept and a quadcopter need to change their orientation to execute different maneuvers.

In a traditional LIDAR system and in the new dynamic tilting LIDAR, both systems will produce the same beam coverage when they are placed on a flat platform as shown in FIG. 6.

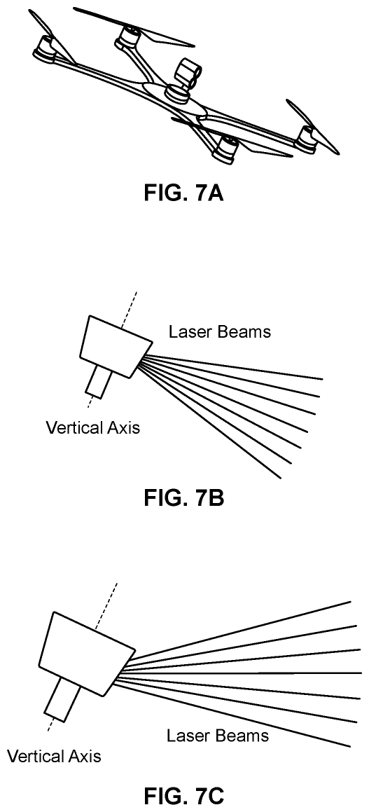

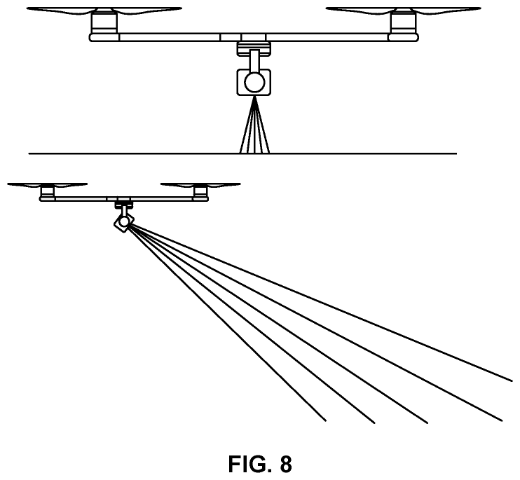

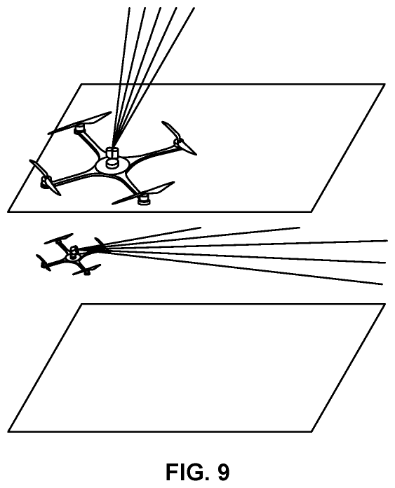

However, when the system is placed on an inclined platform such as an aerial robot, as shown in FIGS. 7A-7C, then the beams of the traditional LIDAR will start to cover areas that may not be of interest to the aerial robot. The area covered by the traditional LIDAR when inclined is shown in FIGS. 7A-7C. On the other hand, the dynamic tilt LIDAR can adjust its tilt mechanism to change the angle of the beams and thus it can produce a similar covered area to the platform which has no inclination in the region of interest. The disclosed LIDAR can read platform inclinations using the integrated IMU module or an external angle sensor in the robot system which can be fed to the LIDAR.

For an aerial robot, with vertical take-off and landing (VTOL), the variable dynamic vertical FOV can be adjusted according to which stage is the robot in. For example, during take-off, for a robot having the LIDAR mounted on the bottom of the robot, the FOV can be adjusted to face the ground and read how far the robot is away from the ground. The same FOV can be used for landing. Once the robot takes off, the FOV can be then adjusted to detect nearby object around the robot.

In a different implementation where the LIDAR is placed on top of the aerial vehicle, the LIDAR adjusts the tilt angle such that it scans the volume above the robot and check for potential obstacles. Once the robot takes off and gains enough height in its environment, the vertical FOV is adjusted such that it scans the volume around the robot to identify the obstacles that could potentially limit the robot's motion in forward, backward or sideways directions.

Additionally, with an aerial platform, two LIDAR units can be used, one on top of the robot and another underneath it. This would result in a full coverage up to 360 degrees in both vertical and horizontal FOV, thereby eliminating any dead zone. The lower LIDAR system of the invention can further be used for landing and take-off purposes.

According to an embodiment of the present disclosure, a method for linking the robot motion and the robot orientation with the LIDAR configuration is provided. Scanning the region around an autonomous mobile robot is usually done with LIDAR systems. To minimize the dead-zone of the LIDAR, a large number of beams is added. This contributes to increasing the cost of the LIDAR unit. For autonomous cars, LIDAR systems with 32, 64 and 128 beams are used. In many implementations, more than one LIDAR is used to cover the full environment around the vehicle. The cost of such system ranges approximately between $8,000-$20,000 and in some cases goes even higher figures. A method to utilize the dynamic tilt system to reduce the required number of beams or LIDAR units is disclosed herein. The motion of the mobile robot can be linked to the LIDAR. The LIDAR can estimate the nature of the platform to which it is connected. It can also receive information from the user or other external input about the robot dimensions and calibrate its beams based on robot dimensions to find the lowest angle possible. The LIDAR starts scanning at the lowest angle. This means the robot starts by scanning the ground around itself. During the scanning, at least some of the beams may intersect with the ground. According to the robot geometry and LIDAR placement, the LIDAR system can determine which beams are supposed to intersect a flat ground. Based on the robot geometry and the angle of the beam, a beam is expected to intersect a flat ground at a specific point. Since multiple points are taken from the ground reflection at different horizontal angles, using trigonometry or other suitable algorithms for line or plane fitting, the LIDAR system can identify the change in road grade and further adjust the angle of the beams.

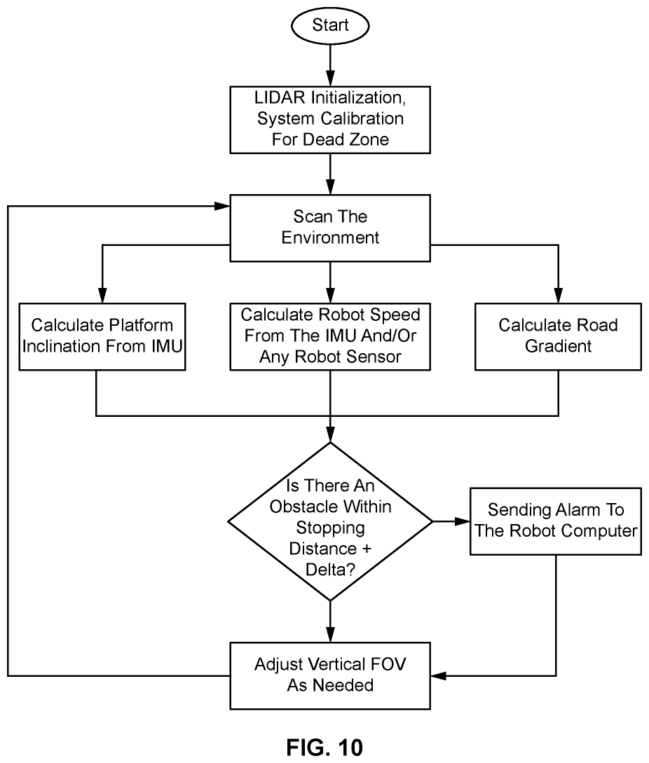

Then, once in motion, the robot adjusts the vertical angle of the laser sensor and the beams. If the robot velocity increases, the beams move upward to cover a longer distance, and if it slows down, the beams move downward to cover smaller radius around the robot. The size of the radius of coverage around the robot can be set based on the stopping distance at different operational speeds. The process of checking for obstacles, checking the road gradient, modifying the beams' vertical angle happen in real time based on the robot velocity. If an obstacle is found, the LIDAR sends an alarm to the robot to decrease its velocity. The extent of braking depends on the obstacles' locations and the speed of the robot. The flowchart illustrated in FIG. 10 is an overview of the process. FIG. 10 shows the steps that the robot goes through and how the speed and the LIDAR beams are changed accordingly. The relation between the current vertical FOV of LIDAR and the robot motion can be set adaptively by the LIDAR based on the range of speeds achievable by the robot which is to be provided by the user, or alternatively, a software in the robot control system sends a command to set the vertical FOV according to the user request.

According to yet another embodiment of the present disclosure, a method for linking the robot motion and the robot orientation with the LIDAR configuration is provided. For example, a method to utilize the dynamic tilt system to reduce the required number of beams is disclosed here. The motion of the mobile robot can be controlled through the LIDAR. The LIDAR receives the robot dimensions from the user and calibrates its beams based on robot dimensions to find the lowest angle possible. The LIDAR starts scanning the ground around the robot at the lowest angle. During the scanning, some of the beams will intersect with the ground. According to the robot geometry and LIDAR placement, the LIDAR system can determine which beams are supposed to intersect a flat ground. Based on the robot geometry and the angle of the beam, a beam is expected to intersect a flat ground at a specific point. Since multiple points are taken from the ground reflection at different horizontal angles, using trigonometry or other algorithms for line or plane fitting, the LIDAR system can identify the change in road grade and further adjust the angle of the beams.

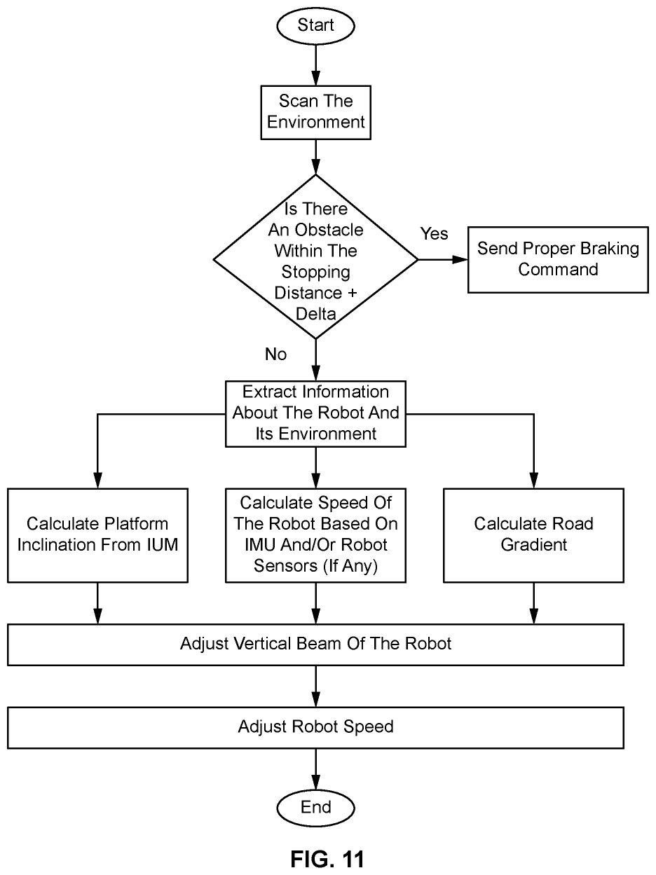

When in motion, as long as there is no obstacle around the robot, the LIDAR sends commands to the robot to increase its speed until a threshold for the vertical angle is reached or the speed threshold is reached. The process of checking for obstacles, checking the road gradient, modifying the beams vertical angle, then increasing the speed is repeated until the desired speed is reached or an obstacle is found before the desired speed is reached. If an obstacle is found, the LIDAR sends a braking command to the robot to decrease its velocity. The intensity of braking depends on the obstacle's location and the speed of the robot. The flowchart illustrated in FIG. 11 is an overview of the process, showing the steps that the robot goes through and how the speed and the LIDAR beams are changed accordingly.

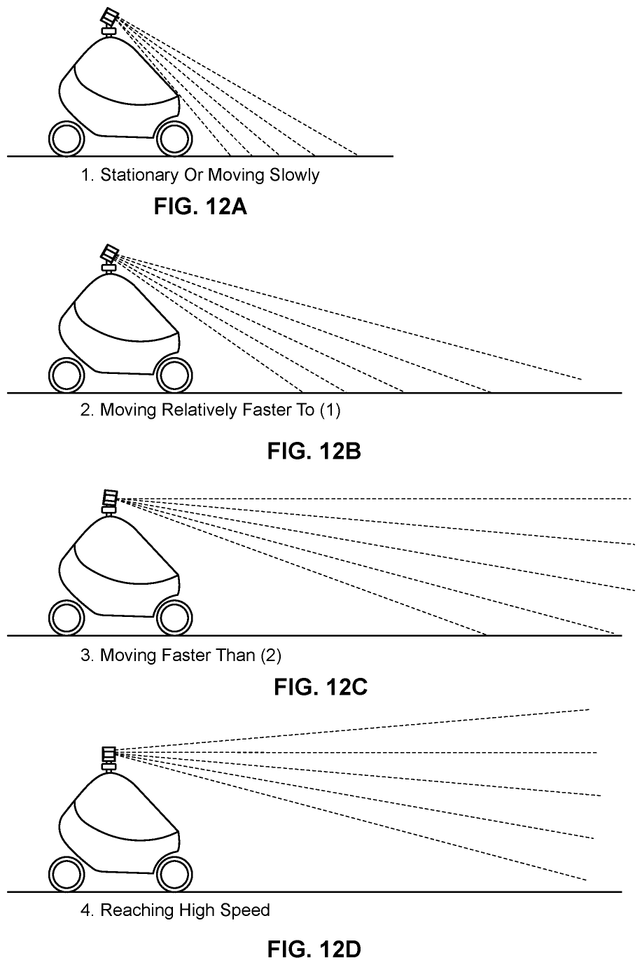

With the ability to change the vertical angle of the laser beams as illustrated in FIGS. 12A-12D, the shape of the robot can be constructed such that it takes a conical or semi conical shape to reduce the dead zone. When designed properly, a zero dead zone robot can be designed.

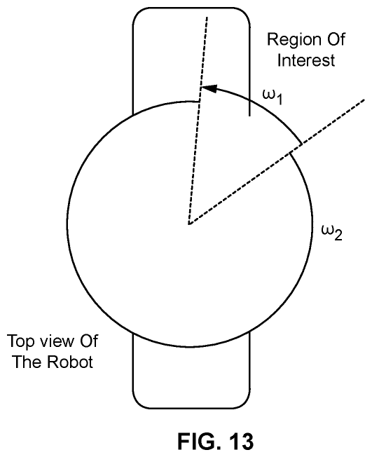

During the robot motion, the LIDAR beams can be adjusted according to the next motion to be executed by the robot, so as to scan some regions in the environment more cautiously than other regions. For example, the robot is moving on a straight line. According to the planning system, the next move is to turn right. The LIDAR can then be operated to preferentially scan the region to the right of the robot. In FIG. 13, the LIDAR can adjust its speed of rotation inside and outside the region of interest. When inside the region of interest, the LIDAR will rotate at a slower rate to get more data about the environment. Once outside the region of interest, the LIDAR will still scan but with a higher rotational speed collecting fewer data points about the environment.

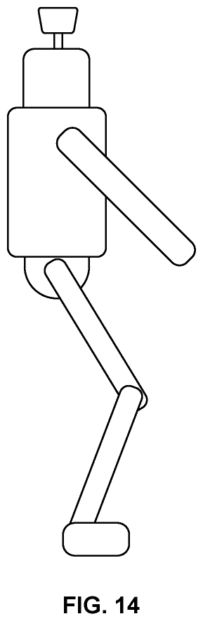

Humanoid robots or walking robots, in general, have a high degree of freedom as illustrated in FIG. 14. The system pose can take a large number of possibilities in the configuration of the robot. Under any of these poses, the robot might need to scan a specific region in the environment to execute the next action. With the ability to read the orientation of the platform from the IMU as well as from the robot sensors, the vertical and horizontal field of view, as well as the scanning speed, can be adjusted either automatically by the LIDAR control system or through commands from the robot computer.

According to an embodiment of the present disclosure, a LIDAR system is configured to estimate the pose of a robot. The data from the IMU can be used to obtain the attitude of the robotic platform. This attitude can then be used to construct a transformation matrix to transform the observed points from a body frame to a global or inertial frame. FIGS. 14A-14C illustrate an example with a single beam LIDAR for simplification. (r) here is a vector that describes the position of the body frame attached to the drone with respect to the global frame. The detected point of the object is a distance (d) along the body frame x-axis. To build a map of the environment, the point needs to be expressed in the global frame coordinates. A general equation 1 describing this transformation is as follows:

$$\vec{R} = \vec{r} + M \vec{d} \\ [ \begin{matrix}{x}_{global} \\ {y}_{global}\end{matrix} ] = [ \begin{matrix}{x}_{body / g lobal} \\ {y}_{body / g lobal}\end{matrix} ] + M [ \begin{matrix}{x}_{body} \\ {y}_{body}\end{matrix} ]$$

where M is a rotation matrix that relates the orientation between the body frame and the global frame.

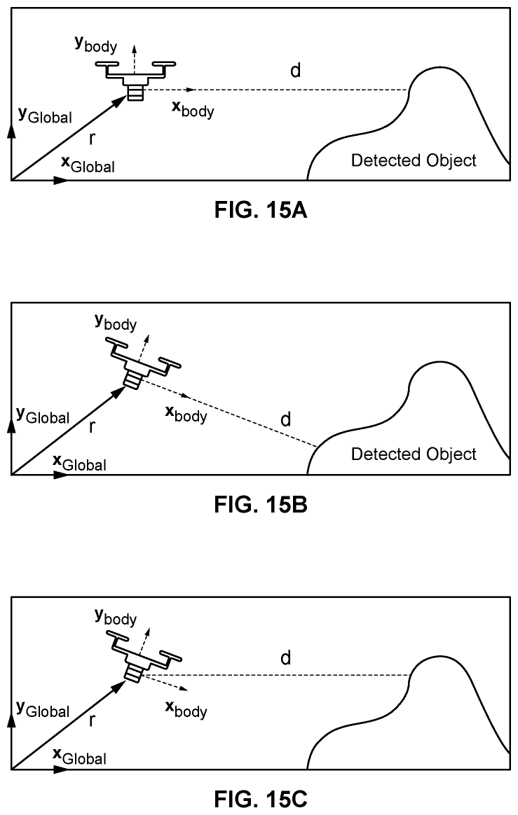

The attitude angles extracted from the IMU data can be used to construct this matrix and transform the measured distance into the global map. In the case of the disclosed invention, the IMU is not used only to extract the attitude angles; it is further used to correct the current orientation of the LIDAR beam through an actuator that changes the vertical orientation of the beam. In FIG. 15A, the two systems would work in exactly the same way. However, from FIG. 15B and FIG. 15C, the difference between the systems is clear. FIG. 15B illustrates an aerial robotic having a traditional LIDAR and FIG. 15C illustrates an aerial robotic having a new LIDAR with Inertial Measurement Unit (IMU).

According to an embodiment, the IMU has an accelerometer inside, the acceleration along the three body axes (x,y,z). Single integration of these quantities results in an estimate of the platform velocity and a double integration would result in the platform position. In most implementations, this data from the IMU is fused with other measurements from other sensors such as a GPS system to correct the drift in the IMU data. This is usually classified as dead reckoning algorithm. LIDAR points have also been used to further enhance the performance of dead reckoning algorithms. In the current innovation however, although the IMU is used to extract motion data of the platform, the extracted data is used to set the vertical angle of the beams according to the estimated velocity. This way, the LIDAR beams' angles are set dynamically according to the motion of the robotic platform. Further, the orientation is used to correct for any platform inclination by adjusting the beams' vertical angle.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A light detection and ranging (LIDAR) device configured to predict a motion of a robot, comprising:
at least a laser beam configured to cover up to 360 degrees around the LIDAR device,
a mechanism includes one or more electromechanical actuators, configured to control a tilt angle of the at least laser beam, and
an Inertial Measurement Unit (IMU) configured to estimate a pose of a platform.

2. The LIDAR device according to claim 1, wherein the mechanism is one or more electromechanical actuators, MEMEs, optics, or any other suitable actuators.

3. The LIDAR device according to claim 2, wherein the mechanism is configured to set a field of view for a scanning process.

4. The LIDAR device according to claim 2, wherein the mechanism is configured to change the horizontal and vertical field of view of the laser beam.

5. The LIDAR device according to claim 2, wherein the mechanism dynamically changes the horizontal-vertical field of view and the vertical field of view in real-time based on the orientation of the robot, speed of the robot, or data feed from the robot.

6. The LIDAR device according to claim 2, wherein the mechanism controls the vertical angle of the laser beam in closed loop control or any other control regime.

7. The LIDAR device according to claim 1, further comprises a laser sensor with wide angle of separation in the vertical field of view configured to cover the larger vertical field of view.

8. The LIDAR device according to claim 7, wherein the laser sensor scans through the vertical field of view without any rotation in the horizontal field of view.

9. The LIDAR device according to claim 7, wherein the laser sensor scans through the horizontal field of view without changing the vertical field of view.

10. The LIDAR device according to claim 1, wherein the Inertial Measurement Unit includes at least a rate gyro configured to measure rotational rates and an accelerometer configured to measure translational accelerations.

11. The LIDAR device according to claim 1, wherein the Inertial Measurement Unit is configured to measure an orientation of a robot.

12. The LIDAR device according to claim 1, wherein the Inertial Measurement Unit is configured to measure a motion of a robot.

13. A control method of a LIDAR device of claim 1, comprising:
linking a robot motion with a LIDAR device configuration, and
linking a robot orientation with the LIDAR device configuration.
